(19) United States
(12) Patent Application Publication
(10) Pub. No.: US 2017/0036331 A1
(43) Pub. Date: Feb. 9, 2017

(54) SWIVELING TOOL FOR ROOF CARRIER CROSS BAR INSTALLATION

(71) Applicant: GM Global Technology Operations LLC, Detroit, MI (US)

(72) Inventors: CARLOS A. MARTINEZ, WINDSOR (CA); CHRISTOPHER GEORGE, DRYDEN, MI (US)

(21) Appl. No.: 15/158,724

(22) Filed: May 19, 2016

Related U.S. Application Data
(60) Provisional application No. 62/201,732, filed on Aug. 6, 2015.

(51) Int. Cl. B25B 23/142; B25B 27/00; B25G 1/00

(52) U.S. Cl. CPC B25B 23/1427; B25G 1/007; B25B 27/0035

(57) ABSTRACT

A product may include a first section that may be disposed around an axis. A second section may be connected to the first section to pivot relative to the first section between a first operative position and a second operative position. In the first operative position, the first section may be aligned with the second section along the axis. In the second operative position, the first section may form a crank to rotate the second section. A graduated piece may be fixed to the first section and an indicator piece may be fixed to the product to indicate torque relative to the graduated piece.

### CROSS REFERENCE TO RELATED APPLICATIONS

This application claims benefit of United States Provisional Application No. 62/201,732 filed Aug. 6, 2015.

### TECHNICAL FIELD

The field to which the disclosure generally relates includes fastening tools, and in particular may include fastening tools for roof carrier cross bar installation.

### BACKGROUND

Tools may be used in various applications such as those involving automobiles, which may have a cargo rack, often on a trunk lid panel or roof panel. The cargo rack may include side rails connected to the respective panel, which generally run longitudinally along the vehicle. Cross rails may extend between the side rails and may be optionally installed to assist in carrying objects. The cross rails may be removable, and may include releasable connections to the side rails, and tools may be employed to secure or release the connections.

### SUMMARY OF ILLUSTRATIVE VARIATIONS

A number of illustrative variations may involve a product that may include a first section that may be disposed around an axis. A second section may be connected to the first section to pivot relative to the first section between a first operative position and a second operative position. In the first operative position, the first section may be aligned with the second section along the axis. In the second operative position, the first section may form a crank to rotate the second section. A graduated piece may be fixed to the first section and an indicator piece may be fixed to the product to indicate torque relative to the graduated piece.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a side view of a product according to a number of variations.

FIG. 2 is a view of the product of FIG. 1, from another direction, according to a number of variations.

FIG. 3 is a fragmentary view of a joint part of the product of FIGS. 1 and 2 shown in a first operative position.

FIG. 4 is a fragmentary view of a joint part of the product of FIGS. 1 and 2 shown in a second operative position.

FIG. 5 is an illustration of a product according to a number of variations in use with a cross bar installation, in a driving operation.

FIG. 6 is an illustration of a product according to a number of variations in use with a cross bar installation, in a torqueing operation.

### DETAILED DESCRIPTION OF ILLUSTRATIVE VARIATIONS

The following description of the variations is merely illustrative in nature and is in no way intended to limit the scope of the invention, its application, or uses.

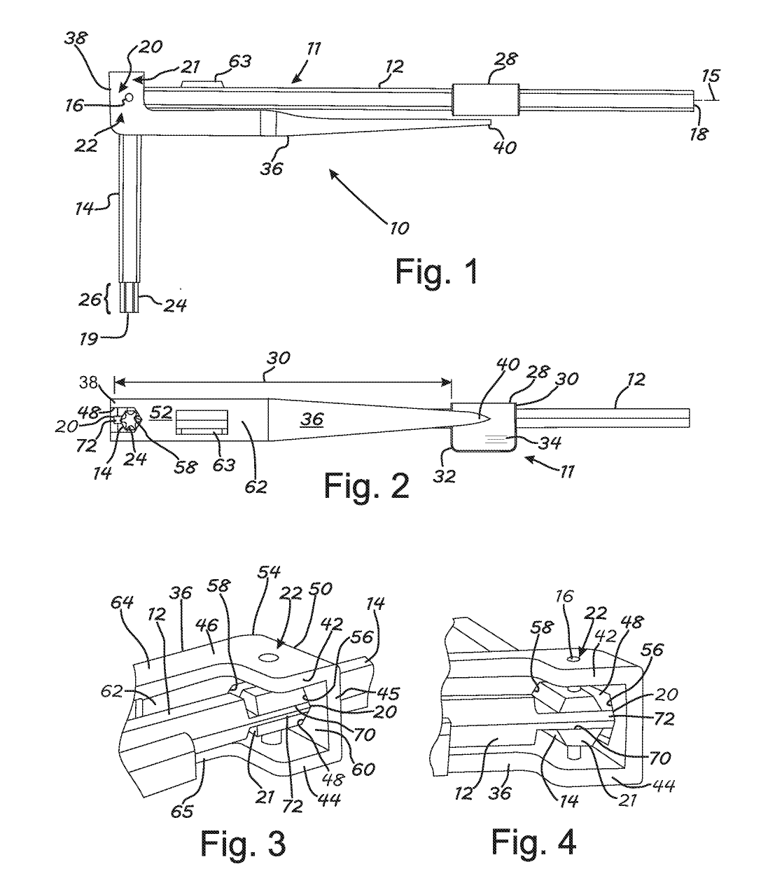

In applications such as assembling a cross bar to a side rail for a vehicle cargo carrier, one of the challenges in efficient fastening is to drive quickly and yet torque to the proper level without over-tightening. In a number of applications, the fasteners may be relatively close to a panel of the vehicle, and so a long handled torque wrench may have limited travel. As such, repeated withdrawal and reapplication of the torque wrench is typically needed. In a number of variations, a product 10 as illustrated in FIG. 1 may be a swiveling torque wrench 11 that may include a first section 12 and a second section 14, which may be connected by a pin 16. The first section 12 may be comprised of an elongated section of rigid stock that may have a hexagonal shaped cross section. The first section 12 may extend between a first end 18 and a second end 20, generally along an axis 15. The second section 14 may be comprised of an elongated section of stock that may have a hexagonal shaped cross section. The second section 14 may extend between a first end 19 and a second end 21. The first end 19 of the second section 14 may have a tool tip 24 that may be formed to mate with a type of fastener used in the application for which the swiveling torque wrench 11 may be used. In a number of variations, the tool tip 24 may include a segment 26 at or adjacent the end 19 that is hexalobular in shape, meaning that it may have a cross sectional shape with six points distributed around it's outer circumference with concave curved surfaces between each pair of adjacent points, as visible in FIG. 2. The second section 14 may be connected to the first section 12 at the second ends 19 and 20 through a joint 22 that may allow the first and second sections 12, 14 to pivot or swivel relative to each other.

With additional reference to FIG. 2, in a number of variations the first section 12 may have a graduated piece 28 that may be fixed between the first and second ends 18, 20. The graduated piece 28 may be spaced from the second end 20 a distance 30, wherein the segment of the first section 12 between the end 20 and the graduated piece 28 may be sufficient to enable deflection or bending when the swiveling torque wrench 11 is used and the desired torque is reached in the associated fastener. The distance 30 will be selected based on the material used for the first section 12 and the torque level specified for the application, as one skilled in the art will understand. The graduated piece 28 may be flag shaped and may have an opening that may match and may receive the first section 12. The opening may be slightly smaller than the cross section of the first section 12 so that the graduated piece 28 may be pressed on and held in place by friction, or the graduated piece 28 may be secured by an adhesive, a fastener or other suitable means. The graduated piece 28 may have a base section 30 that may be secured to the first section 12 and may have flag section 32 that may extend laterally away from the first section 12. In a number of variations the graduated piece 28 may have at least one gradation 34 to indicate that the desired torque level has been reached. In other variations a number of gradations may be included and other reference information may be included on the graduated piece 28, such as numerals, to provide indication of various torque levels.

In a number of variations, torque may be indicated by an indicator piece 36, which may be secured at the second ends 20, 21, such as by the pin 16. The indicator piece 36 may extend between a head 38 and a pointer 40. The pointer 40 may be disposed over the graduated piece 28, and at rest may be in line with the first section 12. With additional reference to FIG. 3, the indicator piece 36 may have a plate section 62 that may be substantially flat with a pair of sides 64 and 65 extending away from the edges of the plate section 62 and along its length. A clip 63, as shown in FIGS. 1 and 2, may extend from the plate section 62 and around a segment of the first section 12 to hold the indicator piece 36 against the first section 12. The head 38 may have a pair of legs 42 and 44 that may be spaced apart a distance sufficient to allow the second section 14 to pass between them. The legs 42, 44 may extend from a base 45 and the body 46, and may be substantially perpendicular to the body 46 of the indicator piece 36. The indicator piece 36 may define an opening 48 through its end 50 and face 52. The end 50 may be defined opposite the pointer 40 end and the face 52 may be defined as a surface facing away from the first section 12. The opening 48 may extend around the corner 54 between a driver stop 56 and a torque wrench stop 58. The driver stop 56 may be formed by a section 60 that may span between the legs 42, 44 adjacent their terminal ends. The torque wrench stop 58 may be formed by the plate section 62.

In a number of variations, the second section 14 may pivot relative to the first section 12 through an angular range between the driver stop 56 and the torque wrench stop 58, which may be 90 degrees. The driver stop 56 may place the second section 14 at an orientation that may be 180 degrees (or approximately thereabout), relative to the first section 12 as shown in FIG. 3, and may extend along the axis 15. This orientation may place the swiveling torque wrench 11 in a first operative position that may place the first and second sections 12, 14 in alignment so that the swiveling torque wrench 11 may be used as a driver and may be rapidly rotated within tight lateral clearance spaces. When repositioned against the torque wrench stop 58, the second section 14 may be placed at an orientation that may be 90 degrees (or approximately thereabout), relative to the first section 12 (and the axis 15). This orientation may place the swiveling torque wrench 11 in a second operative position with the first and second sections in a “crank” orientation as shown in FIG. 4 so that the first section 12 may be used to crank or rotate the second section 14 with leverage to apply torque.

With additional reference to FIG. 4, the joint 22 may include the pin 16 that may extend through the first and second sections 12, 14 and the legs 42, 44. The second section 14 may have a slot 70 through its second end 21, which may extend laterally completely through the second section 14. The slot 70 may receive a blade 72 formed by a reduced cross section segment at the end 20 of the first section 12. The blade 72 may be oriented with its flat shape disposed in a plane parallel to the legs 42, 44. The legs 42, 44 may be secured by the pin 16 on opposite sides of the second section 14. The blade 72 may extend into the opening 48 and may rest therein against the driver stop 56.

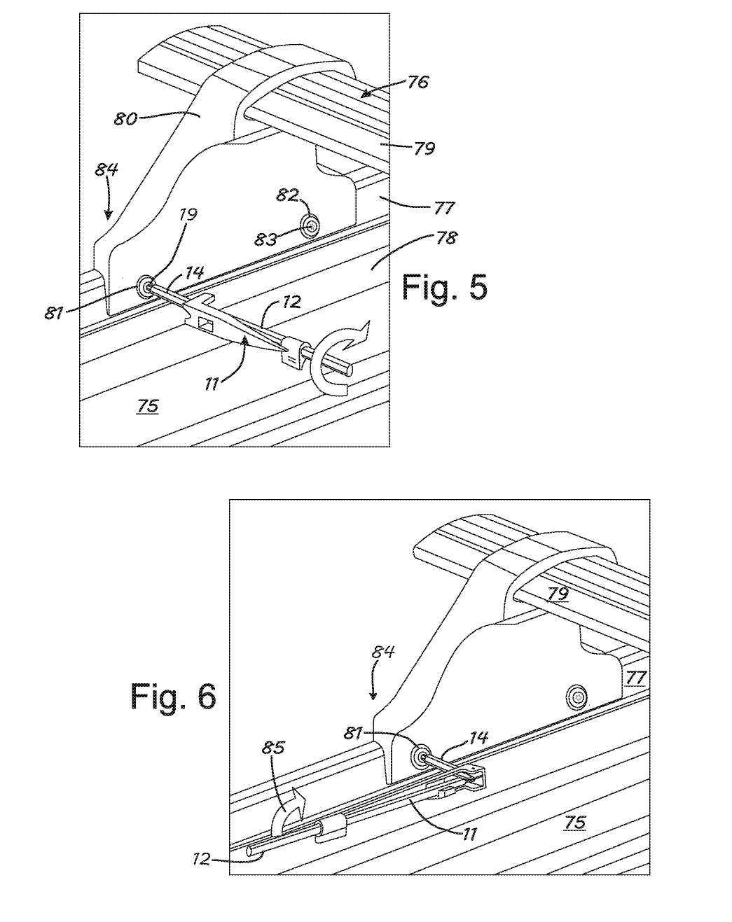

In a number of variations as illustrated in FIGS. 5 and 6, a vehicle 75 may have a roof carrier 76 that may include a side rail 77 connected with a roof panel 78. A cross bar 79 may be secured to the side rail 77 by a bracket 80 and a pair of fasteners 81 and 82. The fasteners 81, 82 may extend through the bracket 80 of the cross bar 79, and may be threaded into the side rail 77. The fasteners 81, 82 may be bolts and may have a hexalobular receptacle 83. In a number of variations a method of applying the fasteners 81, 82 to attach the cross bar 79 to the side rail 77 may involve use of the swiveling torque wrench 11. The swiveling torque wrench 11 may be placed in the first operative position as shown in FIG. 5. The tool tip 19 may be engaged within the hexalobular receptacle 83 of the fastener 81. With the swiveling torque wrench 11 in the first operative position, it may be gripped and rotated repeatedly to thread the fastener 81 into the bracket 80. With clearance limited by the adjacent root panel 78, the swiveling torque wrench 11 does not need to be removed until the fastener 81 is snugged up. The swiveling torque wrench 11 may then be removed from the hexalobular receptacle 83 and may be repositioned to the second operative position as shown in FIG. 6. Optionally, the swiveling torque wrench 11 may be repositioned without being removed from the fastener 81, depending on its rotational orientation. With the second section 14 positioned at approximately 90 degrees relative to the first section 12, and the tool tip 19 engaged in the hexalobular receptacle 83, the gradations 34 face toward the outside 84 of the vehicle 75 where the user may be standing. With the swiveling torque wrench 11 in the second operative position and engaged with the fastener 81, it may be rotated as indicated at 85 with the first section 12 acting as a crank to rotate the second section 14, torqueing the fastener 81. The user may read the location of the pointer 40 of the indicator piece 36 relative to the gradation 34 of the graduated piece 28 while applying torque. The swiveling torque wrench 11 may be disengaged from the fastener 81 when the pointer 40 aligns with the designated or full torque gradation 34 on the graduated piece 28. In this way the fasteners 81, 82 may be efficiently applied to the roof carrier 76 at the specified torque.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may involve product that may include a first section that may be disposed around an axis. A second section may be connected to the first section to pivot relative to the first section between a first operative position and a second operative position. In the first operative position, the first section may be aligned with the second section along the axis. In the second operative position, the first section may form a crank to rotate the second section. A graduated piece may be fixed to the first section and an indicator piece may be fixed to the product to indicate torque relative to the graduated piece.

Variation 2 may include the product according to variation 1 wherein the second section may be perpendicular to the first section in the second operative position.

Variation 3 may include the product according to variation 1 or 2 wherein the first and second sections may be connected by a pin that may also be connected to the indicator piece.

Variation 4 may include the product according to any of variations 1 through 3 wherein when in the second operative position, the second section may extend from a side of the first section and wherein the graduated piece may include at least one gradation mark facing away from the side.

Variation 5 may include the product according to any of variations 1 through 4 wherein one of the first or second sections may define a slot and the other of the first or second sections may have a segment with a reduced cross section positioned in the slot.

Variation 6 may include the product according to variation 5 and may include a pin extending through the reduced cross section fixing the first and second sections together.

Variation 7 may include the product according to variation 6 wherein the pin may extend through the indicator piece.

Variation 8 may include the product according to variation 7 wherein the indicator piece may have a clip that may secure the indicator piece to the second section.

Variation 9 may include the product according to any of variations 1 through 8 wherein the first section may have a cross section that may be hexagonal and the second section may have a tool tip that may be hexaiobular shaped.

Variation 10 may involve a swiveling torque wrench that may include a first section and a second section that may have a tool tip. A joint may connect the second section with the first section to pivot between a first operative position where the first section may be substantially aligned with the second section, and a second operative position where the first section may form a crank to rotate the second section. A graduated piece may be fixed to the first section and an indicator piece may be fixed to the second section. The indicator piece may have a head that may extend over the joint and may have a pointer extending over the graduated piece.

Variation 11 may include the swiveling torque wrench according to variation 10 wherein the head may define an opening where the first section may extend through the opening when in the second operative position and may engage the head as a driver stop.

Variation 12 may include the swiveling torque wrench according to variation 11 wherein the second section may extend through the opening when in the second operative position, and may engage the head as a torque wrench stop opposite the driver stop.

Variation 13 may include the swiveling torque wrench according to any of variations 10 through 12 and may include a pin that may extend through the first and second sections, and the head.

Variation 14 may include the swiveling torque wrench according to any of variations 10 through 13 wherein the joint may include a slot defined by one of the first or second sections and a mating blade on the other of the first or second sections.

Variation 15 may include the swiveling torque wrench according to any of variations 10 through 14 wherein when in the second operative position, the second section may extend from a side of the first section and wherein the graduated piece may include at least one gradation mark facing away from the side.

Variation 16 may include the swiveling torque wrench according to any of variations 10 through 15 wherein the head may have a pair of legs that may be substantially perpendicular to the indicator piece. The legs may have a pair of terminal ends. A driver stop may connect the pair of terminal ends and the second section may be positioned against the driver stop when the second section is in the first operative position.

Variation 17 may include the swiveling torque wrench according to variation 16 wherein the pair of legs may each have a base. A torque wrench stop may extend across the bases. The second section may be positioned against the torque wrench stop when the second section is in the second operative position.

Variation 18 may include the swiveling torque wrench according to any of variations 10 through 17 wherein the graduated piece may have a clip that may be secured on the first section.

Variation 19 may include the swiveling torque wrench according to any of variations 10 through 18 wherein the first and second sections may have a hexagonal cross section and the tool tip may be hexalobular.

Variation 20 may involve a method of applying a fastener to attach a cross bar to a side rail. A swiveling torque wrench may be provided and may a first section and a second section that may have a tool tip. A first operative position may be provided where the first section may be substantially aligned with the second section. A second operative position may be provided where the first section may form a crank to rotate the second section. A graduated piece may be fixed to the first section and may have a full torque gradation. An indicator piece may be fixed to the second section. The swiveling torque wrench may be positioned in the first operative position. The tool tip may be engaged with the fastener when the swiveling torque wrench is in the first operative position. The swiveling torque wrench may be rotated when in the first operative position, driving the fastener to connect the cross bar to the side rail. The swiveling torque wrench may be repositioned to the second operative position. The fastener may be torqued with the swiveling torque wrench while in the second operative position by cranking the second section with the first section. The indicator piece may be read relative to the graduated piece. The swiveling torque wrench may be disengaged from the fastener when the indicator piece may align with the full torque gradation on the graduated piece.

What is claimed is:

1. A product comprising a first section that is disposed around an axis, a second section connected to the first section to pivot relative to the first section between a first operative position and a second operative position, in the first operative position the first section aligned with the second section along the axis and in the second operative position the first section forming a crank to rotate the second section, with a graduated piece fixed to the first section and an indicator piece fixed to the product to indicate torque relative to the graduated piece.

2. The product according to claim 1 wherein the second section is perpendicular to the first section in the second operative position.

3. The product according to claim 1 further comprising a pin connecting the first and second sections, and the pin is also connected to the indicator piece.

4. The product according to claim 1 wherein when in the second operative position, the second section extends from a side of the first section and wherein the graduated piece includes at least one gradation mark facing away from the side.

5. The product according to claim 1 wherein one of the first or second sections defines a slot and the other of the first or second sections has a segment with a reduced cross section that is positioned in the slot.

6. The product according to claim 5 further comprising a pin extending through the reduced cross section fixing the first and second sections together.

7. The product according to claim 6 wherein the pin extends through the indicator piece.

8. The product according to claim 7 wherein the indicator piece has a clip that secures the indicator piece to the second section.

9. The product according to claim 1 wherein the first section has a cross section that is hexagonal and the second section has a tool tip that is hexalobular shaped.

10. A swiveling torque wrench comprising a first section, a second section that has a tool tip, a joint connecting the second section with the first section to pivot between a first operative position where the first section is substantially aligned with the second section, and a second operative position where the first section forms a crank to rotate the second section, with a graduated piece fixed to the first section and an indicator piece fixed to the second section, the indicator piece has a head extending over the joint and a pointer extending over the graduated piece.

11. The swiveling torque wrench according to claim 10 wherein the head defines an opening where the first section extends through the opening when in the second operative position and engages the head as a driver stop.

12. The swiveling torque wrench according to claim 11 wherein the second section extends through the opening when in the second operative position and engages the head as a torque wrench stop opposite the driver stop.

13. The swiveling torque wrench according to claim 10 further comprising a pin extending through the first and second sections and the head.

14. The swiveling torque wrench according to claim 10 wherein the joint comprises a slot defined by one of the first or second sections and a mating blade on the other of the first or second sections.

15. The swiveling torque wrench according to claim 10 wherein when in the second operative position, the second section extends from a side of the first section and wherein the graduated piece includes at least one gradation mark facing away from the side.

16. The swiveling torque wrench according to claim 10 wherein the head has a pair of legs substantially perpendicular to the indicator piece, the legs have a pair of terminal ends, and further comprising a driver stop connecting the pair of terminal ends and the second section positioned against the driver stop when the second section is in the first operative position.

17. The swiveling torque wrench according to claim 16 wherein the pair of legs each has a base and further comprising a torque wrench stop extending across the bases and the second section positioned against the torque wrench stop when the second section is in the second operative position.

18. The swiveling torque wrench according to claim 10 wherein the graduated piece has a clip secured on the first section.

19. The swiveling torque wrench according to claim 10 wherein the first and second sections have a hexagonal cross section and the tool tip is hexaiobular shaped.

20. A method of applying a fastener to attach a cross bar to a side rail comprising:
a. providing a swiveling torque wrench comprising a first section, a second section that has a tool tip, with a first operative position where the first section is substantially aligned with the second section, and a second operative position where the first section forms a crank to rotate the second section, with a graduated piece fixed to the first section and having a full torque gradation, and an indicator piece fixed to the second section;
b. positioning the swiveling torque wrench in the first operative position;
c. engaging the tool tip with the fastener when the swiveling torque wrench s in the first operative position;
d. rotating the swiveling torque wrench when in the first operative position driving the fastener to connect the cross bar to the side rail;
e. repositioning the swiveling torque wrench to the second operative position,
f. torqueing the fastener with the swiveling torque wrench while in the second operative position by cranking the second section with the first section;
g. reading the indicator piece relative to the graduated piece; and
h. disengaging the swiveling torque wrench from the fastener when the indicator piece aligns with the full torque gradation on the graduated piece.
